(19) United States
(12) Patent Application Publication
(10) Pub. No.: US 2009/0060550 A1
(43) Pub. Date: Mar. 5, 2009

(54) IMAGE FORMING APPARATUS, FIXING DEVICE, AND HEAT-GENERATING ROTARY MEMBER USING INDUCTION HEATING

(76) Inventor: Hiroshi SEO, Sagamihara city (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/198,531

(22) Filed: Aug. 26, 2008

(30) Foreign Application Priority Data
Aug. 31, 2007 (JP) 2007-227070

(51) Int. Cl. G03G 15/20; H05B 6/14

(52) U.S. Cl. 399/69; 399/329; 219/619; 399/328

(57) ABSTRACT

An image forming apparatus includes a fixing device for fixing a toner image on a sheet by applying heat, and including an exciting coil and a heat-generating rotary member. The exciting coil generates a magnetic flux. The heat-generating rotary member performs self-temperature control using a repulsive magnetic flux, and includes a degaussing member, a heat-generating layer, a magnetic shunt alloy layer, and a magnetic flux adjuster. The degaussing member generates the repulsive magnetic flux using the magnetic flux generated by the exciting coil. The heat-generating layer generates heat using the magnetic flux generated by the exciting coil. The magnetic shunt alloy layer is disposed between the exciting coil and the degaussing member, and receives heat generated by the heat-generating layer. The magnetic flux adjuster adjusts an amount of the repulsive magnetic flux generated by the degaussing member.

### CROSS-REFERENCE TO RELATED APPLICATIONS

The present application is based on and claims priority to Japanese Patent Application No. 2007-227070, filed on Aug. 31, 2007 in the Japan Patent Office, the entire contents of which are hereby incorporated herein by reference.

### BACKGROUND OF THE INVENTION

1. Field of the Invention

Exemplary aspects of the present invention relate to an image forming apparatus, a fixing device, and a heat-generating rotary member, and more particularly, to an image forming apparatus, a fixing device, and a heat-generating rotary member using induction heating.

2. Description of the Related Art

A related-art image forming apparatus, such as a copier, a facsimile machine, a printer, or a multifunction printer having at least one of copying, printing, scanning, and facsimile functions, typically forms a toner image on a recording medium (e.g., a sheet) based on image data using electrophotography. Thus, for example, a charger charges a surface of an image carrier. An optical writer emits a light beam onto the charged surface of the image carrier to form an electrostatic latent image on the image carrier according to the image data. A development device develops the electrostatic latent image with a developer (e.g., toner) to form a toner image on the image carrier. The toner image is then transferred from the image carrier onto a sheet. A cleaner cleans the surface of the image carrier after the toner image is transferred from the image carrier. Finally, a fixing device applies heat and pressure to the sheet bearing the toner image to fix the toner image on the sheet, thus forming the toner image on the sheet.

In the fixing device, for example, a fixing roller is disposed opposite and pressed against a pressing roller to form a fixing nip between the fixing roller and the pressing roller. When a sheet bearing a toner image passes between the fixing roller and the pressing roller, that is, through the fixing nip, the fixing roller and the pressing roller apply heat and pressure to the sheet to fix the toner image on the sheet.

Such fixing device may use an induction heating method to generate heat quickly. In one example of the fixing device, an exciting coil generates induction magnetic fluxes to induce heat in a heat-generating layer. Heat generated by the heat-generating layer is transmitted to a magnetic shunt alloy layer provided between the exciting coil and a degaussing member. The degaussing member generates repulsive magnetic fluxes corresponding to the induction magnetic fluxes generated by the exciting coil. Specifically, when a temperature of the magnetic shunt alloy layer is higher than a Curie point, the repulsive magnetic fluxes generated by the degaussing member cancel out the induction magnetic fluxes generated by the exciting coil to activate a self-temperature control function of the fixing device.

The self-temperature control function provides the fixing device with a stable temperature near the Curie point, preventing the heat-generating layer from being heated above the Curie point. However, when a temperature of the heat-generating layer is increased to near the Curie point, the heat-generating layer may provide decreased heat generation efficiency. Accordingly, when the fixing device is located in a low-temperature environment, a long time period is needed to warm up the fixing device. To address this problem, a higher Curie point may be set for the magnetic shunt alloy layer. In dosing so, however, both ends of the fixing roller in an axial direction of the fixing roller may be heated excessively.

Specifically, when a small size sheet passes through the fixing nip, the small size sheet contacts only a center of the fixing roller in the axial direction of the fixing roller without contacting the two ends of the fixing roller, thus drawing heat from the center of the fixing roller. Therefore, after a plurality of small size sheets continuously contacts the center of the fixing roller, a temperature of the center of the fixing roller is lower than a temperature of the two ends of the fixing roller. Consequently, when a toner image on a large size sheet, which contacts both the center and the two ends of the fixing roller, is fixed immediately after the plurality of small size sheets passes through the fixing nip, the fixed toner image on the large size sheet may have an uneven gloss due to the difference in temperature between the center of the fixing roller and the two ends of the fixing roller.

### BRIEF SUMMARY OF THE INVENTION

This specification describes below an image forming apparatus according to an exemplary embodiment of the present invention. In one exemplary embodiment of the present invention, the image forming apparatus includes a fixing device for fixing a toner image on a sheet by applying heat, and including an exciting coil and a heat-generating rotary member. The exciting coil generates a magnetic flux. The heat-generating rotary member performs self-temperature control using a repulsive magnetic flux, and includes a degaussing member, a heat-generating layer, a magnetic shunt alloy layer, and a magnetic flux adjuster. The degaussing member generates the repulsive magnetic flux using the magnetic flux generated by the exciting coil. The heat-generating layer generates heat using the magnetic flux generated by the exciting coil. The magnetic shunt alloy layer is disposed between the exciting coil and the degaussing member, and receives heat generated by the heat-generating layer. The magnetic flux adjuster adjusts an amount of the repulsive magnetic flux generated by the degaussing member.

This specification further describes below a fixing device according to an exemplary embodiment of the present invention. In one exemplary embodiment of the present invention, the fixing device includes an exciting coil and a heat-generating rotary member. The exciting coil generates a magnetic flux. The heat-generating rotary member performs self-temperature control using a repulsive magnetic flux, and includes a degaussing member, a heat-generating layer, a magnetic shunt alloy layer, and a magnetic flux adjuster. The degaussing member generates the repulsive magnetic flux using the magnetic flux generated by the exciting coil. The heat-generating layer generates heat using the magnetic flux generated by the exciting coil. The magnetic shunt alloy layer is disposed between the exciting coil and the degaussing member, and receives heat generated by the heat-generating layer. The magnetic flux adjuster adjusts an amount of the repulsive magnetic flux generated by the degaussing member.

This specification further describes below a heat-generating rotary member according to an exemplary embodiment of the present invention. In one exemplary embodiment of the present invention, the heat-generating rotary member includes a metal sleeve, a roller, and a degaussing member. The metal sleeve includes a heat-generating layer configured to generate heat using a magnetic flux, and a magnetic shunt alloy layer configured to receive heat generated by the heat-generating layer. The roller includes ferrite as a high-resistance magnetic material. The degaussing member is rotatably provided inside the metal sleeve, and includes one of an aluminum plate and a copper plate attached to a part of the roller.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings, wherein:

FIG. 1 is a schematic view of an image forming apparatus according to an exemplary embodiment of the present invention;

FIG. 2 is a sectional front view of a fixing device included in the image forming apparatus shown in FIG. 1;

FIG. 3 is a perspective view of a magnetic flux generator and a fixing roller included in the fixing device shown in FIG. 2;

FIG. 4 is a side view of the magnetic flux generator shown in FIG. 3;

FIG. 5 is a partially enlarged sectional view of a portion of the fixing roller shown in FIG. 3 cut in a radial direction;

FIG. 6A is a sectional front view of the fixing roller shown in FIG. 3 when a magnetic shunt alloy layer included in the fixing roller shown in FIG. 5 does not suppress heat generation;

FIG. 6B is a sectional front view of the fixing roller shown in FIG. 6A when the magnetic shunt alloy layer shown in FIG. 5 suppresses heat generation;

FIG. 7 is a graph illustrating a relation between a temperature and a magnetic permeability of the magnetic shunt alloy layer shown in FIG. 5;

FIG. 8 illustrates a surface temperature of the fixing roller shown in FIG. 3 varying depending on a position on the fixing roller;

FIG. 9A is a sectional front view of a fixing device according to another exemplary embodiment when a degaussing function is activated;

FIG. 9B is a sectional front view of the fixing device shown in FIG. 9A when the degaussing function is not activated;

FIG. 10 is a perspective view of a magnetic core and a degaussing member included in the fixing device shown in FIG. 9A;

FIG. 11 is a sectional side view of the fixing device shown in FIG. 9A;

FIG. 12 is a graph illustrating a relation between a temperature and an amount of heat generated in the fixing device shown in FIG. 11;

FIG. 13 is a block diagram of the fixing device shown in FIG. 11 for explaining an example of heat generation control;

FIG. 14A is a sectional front view of the fixing device shown in FIG. 9A in a normal print mode in which the degaussing function is activated;

FIG. 14B is a sectional front view of the fixing device shown in FIG. 9B in a glossy print mode in which the degaussing function is not activated;

FIG. 15 is a sectional front view of a fixing device according to yet another exemplary embodiment;

FIG. 16A is a sectional front view of a fixing device according to yet another exemplary embodiment when the degaussing function is activated;

FIG. 16B is a sectional front view of the fixing device shown in FIG. 16A when the degaussing function is not activated;

FIG. 17 illustrates a relation among an exciting coil, degaussing coils, a switch element, and an inverter included in the fixing device shown in FIG. 16A;

FIG. 18 is a block diagram of the fixing device shown in FIG. 16A for explaining an example of heat generation control;

FIG. 19A is a sectional front view of the fixing device shown in FIG. 16A in the normal print mode in which the degaussing function is activated;

FIG. 19B is a sectional front view of the fixing device shown in FIG. 16B in the glossy print mode in which the degaussing function is not activated; and

FIG. 20 is a sectional front view of a fixing device according to yet another exemplary embodiment.

### DETAILED DESCRIPTION OF THE INVENTION

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

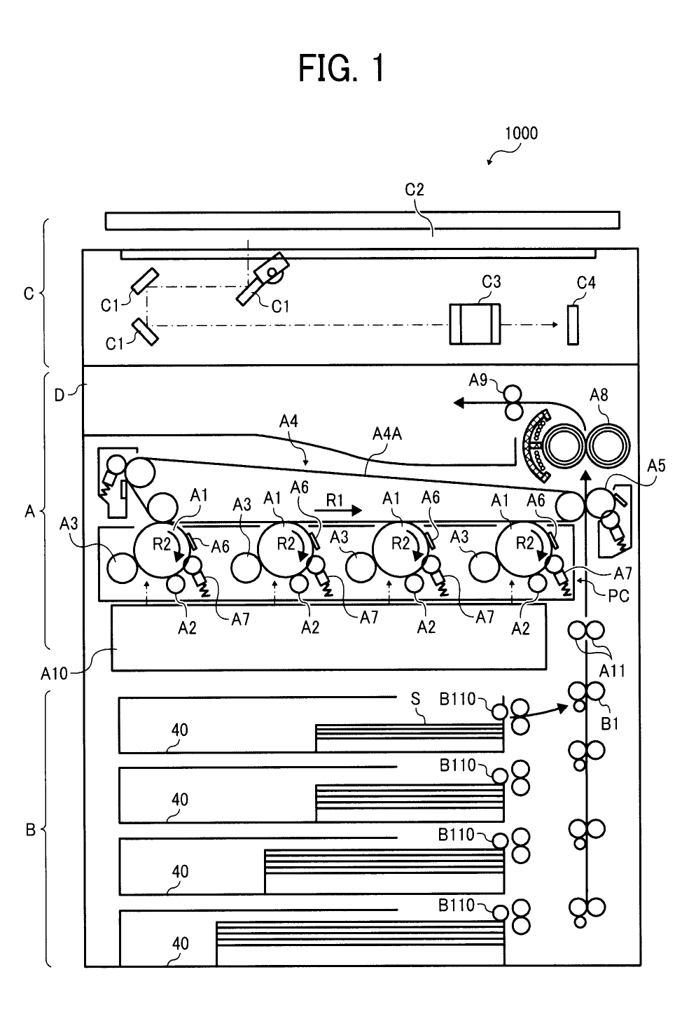

Referring now to the drawings, wherein like reference numerals designate identical or corresponding parts throughout the several views, in particular to FIG. 1, an image forming apparatus 1000 according to an exemplary embodiment of the present invention is explained.

As illustrated in FIG. 1, the image forming apparatus 1000 includes a reading portion C, an image forming portion A, a sheet supply portion B, and a sheet output portion D.

The reading portion C includes an exposure glass C2, a moving scanner C1, a lens C3, and a CCD (charge coupled device) C4.

The image forming portion A includes an exposure device A10, a process cartridge PC, a first transfer device A4, a registration roller pair A11, a second transfer device A5, a fixing device A8, and an output roller A9. The process cartridge PC includes four photoconductors A1, four chargers A2, four development devices A3, four cleaners A6, and four lubricant applicators A7. The first transfer device A4 includes an intermediate transfer belt A4A.

The sheet supply portion B includes paper trays 40, separate-feed members B110, and a feeding roller B1.

The image forming apparatus 1000 can be a copier, a facsimile machine, a printer, a plotter, a multifunction printer having at least one of copying, printing, scanning, plotter, and facsimile functions, or the like. According to this non-limiting exemplary embodiment of the present invention, the image forming apparatus 1000 functions as a color copier for forming a color image on a recording medium by electrophotography. Alternatively, the image forming apparatus 1000 may function as a monochrome copier for forming a monochrome image on a recording medium.

The reading portion C, the sheet output portion D, the image forming portion A, and the sheet supply portion B are provided in this order from a top to a bottom of the image forming apparatus 1000.

In the reading portion C, the moving scanner C1 moves and scans an image on an original document sheet placed on the exposure glass C2 to generate image data. The image data enters the CCD C4 via the lens C3. The CCD C4 converts the image data into an electric signal and sends the electric signal to the exposure device A10 of the image forming portion A.

In the image forming portion A, the first transfer device A4 is provided above the process cartridge PC. The second transfer device A5 is provided beside the first transfer device A4. The fixing device A8 is provided above the second transfer device A5.

The four photoconductors A1 (e.g., photoconductive drums) are arranged along a rotating direction R1 of the intermediate transfer belt A4A. The four photoconductors A1 bear cyan, magenta, yellow, and black toner images, respectively, but have a common structure. The photoconductor A1 rotates in a rotating direction R2. The charger A2, the development device A3, the cleaner A6, and the lubricant applicator A7 surround the photoconductor A1 in this order in the rotating direction R2 of the photoconductor A1. The intermediate transfer belt A4A contacts a surface of the photoconductor A1 at a first transfer area between the development device A3 and the cleaner A6 in the rotating direction R2 of the photoconductor A1. After the charger A2 charges the surface of the photoconductor A1, the exposure device A10 emits a light beam onto the surface of the photoconductor A1 at an exposure area between the charger A2 and the development device A3 in the rotating direction R2 of the photoconductor A1.

The sheet supply portion B includes a plurality of paper trays 40 containing sheets S of various sizes (e.g., small and large sizes), respectively.

The following describes an image forming operation for forming a color toner image on a sheet S.

The four chargers A2 charge the surfaces of the four photoconductors A1, respectively. The exposure device A10 exposes the surfaces of the photoconductors A1 according to image data read by the CCD C4 to form electrostatic latent images on the surfaces of the photoconductors A1, respectively. The development devices A3 develop the electrostatic latent images with cyan, magenta, yellow, and black toners to form cyan, magenta, yellow, and black toner images, respectively.

The first transfer device A4 transfers and superimposes the cyan, magenta, yellow, and black toner images from the photoconductors A1 onto the rotating intermediate transfer belt A4A at the first transfer area to form a color toner image on the intermediate transfer belt A4A. The separate-feed member B110 selectively feeds a sheet S from one of the paper trays 40 toward the feed roller B1 automatically according to original document size information contained in the image data generated by the reading portion C. Alternatively, the separate-feed member B110 feeds a sheet S from one of the paper trays 40 selected by a user. The feed roller B1 feeds the sheet S toward the registration roller pair A11. The registration roller pair A11 temporarily stops the sheet S and feeds the sheet S toward the second transfer device A5 at a proper time when the color toner image is transferred from the intermediate transfer belt A4A onto the sheet S.

The second transfer device A5 contacts the intermediate transfer belt A4A at a second transfer area. When the sheet S fed by the registration roller pair A11 passes through the second transfer area, the color toner image is transferred from the intermediate transfer belt A4A onto the sheet S.

When the sheet S passes through the fixing device A8, the fixing device A8 fixes the color toner image on the sheet S. The output roller A9 feeds the sheet bearing the fixed color toner image onto the sheet output portion D.

Cleaners remove residual toner remaining on the intermediate transfer belt A4A and the second transfer device A5 from the intermediate transfer belt A4A and the second transfer device A5, respectively.

The image forming apparatus 1000, which develops electrostatic latent images with the cyan, magenta, yellow, and black toners, respectively, can selectively form a full-color toner image or a monochrome toner image using one of the cyan, magenta, yellow, and black toners. The full-color toner image may require gloss, but the monochrome toner image, especially the black toner image, may not require gloss. The gloss of a toner image varies depending on a fixing temperature. The image forming apparatus 1000 according to this exemplary embodiment can effectively adjust the fixing temperature in a broad range as described below, and thereby can be used for forming both a glossy image and a non-glossy image.

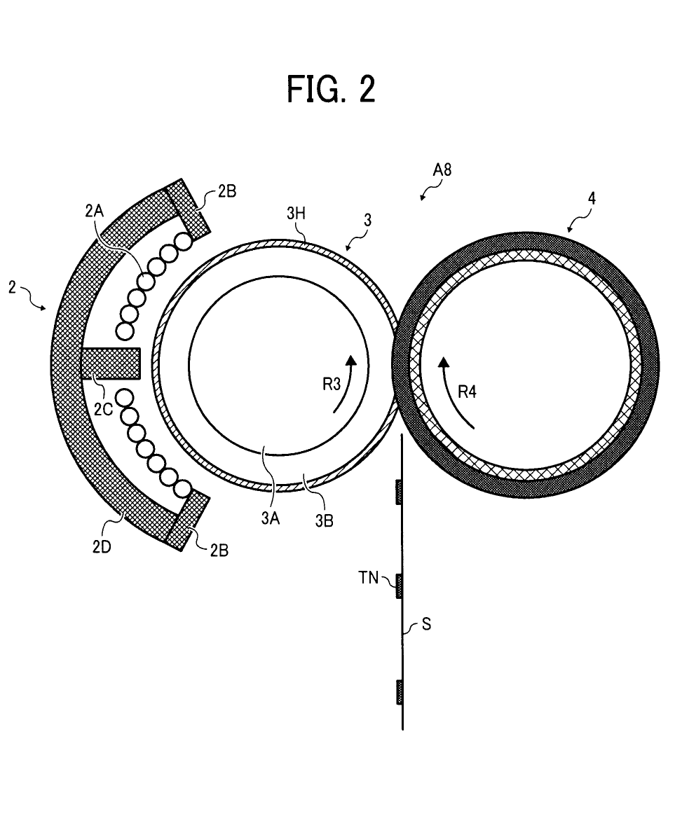

Referring to FIGS. 2 to 4, the following describes the fixing device A8 serving as a reference fixing device. FIG. 2 is a sectional front view of the fixing device A8. The fixing device A8 includes a fixing roller 3, a pressing roller 4, and a magnetic flux generator 2. The magnetic flux generator 2 includes an arch core 2D and an exciting coil 2A. The arch core 2D includes a center core 2C and side cores 2B. The fixing roller 3 includes a degaussing member 3A, an insulating layer 3B, and a metal sleeve 3H.

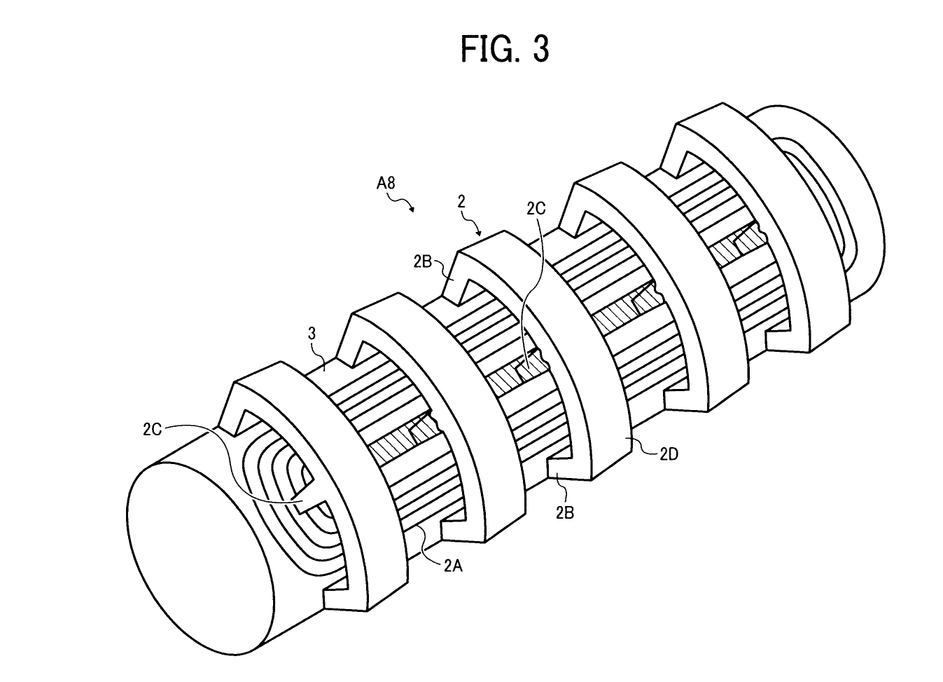

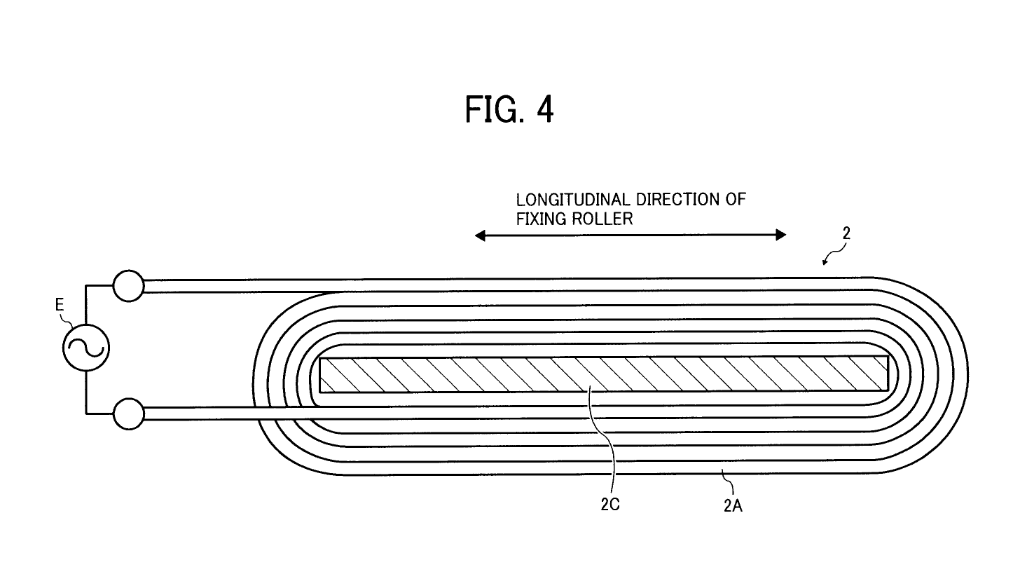

FIG. 3 is a perspective view of the magnetic flux generator 2 and the fixing roller 3. FIG. 4 is a side view of the magnetic flux generator 2. As illustrated in FIG. 4, the magnetic flux generator 2 further includes an inverter E.

As illustrated in FIG. 2, the fixing device A8 fixes a toner image TN on a sheet S in a roller method. The fixing roller 3, serving as a heat-generating rotary member, is disposed opposite and pressed against the pressing roller 4 serving as a pressure-applying rotary member. The fixing roller 3 rotates in a rotating direction R3 and the pressing roller 4 rotates in a rotating direction R4. The magnetic flux generator 2 is provided near an outer circumferential surface of the fixing roller 3 and is fixed in the fixing device A8.

The center core 2C is provided on a center of the arch core 2D, and the side cores 2B are provided on both sides of the arch core 2D. The exciting coil 2A is provided between the arch core 2D and the fixing roller 3 and is formed in a flat coil wound around the center core 2C.

As illustrated in FIG. 4, the inverter E, serving as a drive source, drives the exciting coil 2A with a high frequency to generate a high frequency magnetic field (e.g., a magnetic flux). As illustrated in FIG. 2, the high frequency magnetic field causes an eddy current to flow in the fixing roller 3 including metal and having a roller shape, so as to increase a temperature of the fixing roller 3. When the sheet S bearing the toner image TN passes through a fixing nip formed between the fixing roller 3 and the pressing roller 4 in such a manner that the toner image TN contacts the fixing roller 3, the fixing roller 3 and the pressing roller 4 apply heat and pressure to the sheet S to fix the toner image TN on the sheet S.

In the fixing roller 3, the insulating layer 3B is provided on the degaussing member 3A, and the metal sleeve 3H is provided on the insulating layer 3B.

FIG. 5 is a partially enlarged sectional view of a portion of the fixing roller 3 cut in a radial direction. The metal sleeve 3H includes a magnetic shunt alloy layer 3C, an antioxidant layer 3D1, a heat-generating layer 3E, an antioxidant layer 3D2, an elastic layer 3F, and a releasing layer 3G.

The fixing roller 3 has a diameter of about 40 mm, for example. The degaussing member 3A serves as an innermost metal core. The insulating layer 3B serves as an air layer or a foam layer. The insulating layer 3B, the magnetic shunt alloy layer 3C, the antioxidant layer 3D1, the heat-generating layer 3E, the antioxidant layer 3D2, the elastic layer 3F, and the releasing layer 3G are provided on the degaussing member 3A in this order in a direction G. The releasing layer 3G serves as a surface layer facing the toner image TN on the sheet S (depicted in FIG. 2).

The degaussing member 3A includes aluminum or an alloy of aluminum. The insulating layer 3B formed of air has a thickness of about 5 mm, for example. The magnetic shunt alloy layer 3C includes a known magnetic shunt alloy and has a thickness of about 50 μm, for example. Each of the antioxidant layers 3D1 and 3D2 is nickel-strike plated and has a thickness of not greater than about 1 μm, for example. The heat-generating layer 3E is copper plated and has a thickness of about 15 μm, for example. The elastic layer 3F includes a silicon rubber and has a thickness of about 150 μm, for example. The releasing layer 3G includes PFA (perfluoroalkoxy) and has a thickness of about 30 μm, for example. Thus, the metal sleeve 3H has a thickness in a range of from about 200 μm to about 250 μm, for example.

The magnetic shunt alloy layer 3C includes a magnetic material (e.g., a magnetic shunt alloy material including iron and nickel) having a Curie point in a range of from about 100 degrees centigrade to about 300 degrees centigrade, for example. The magnetic shunt alloy layer 3C is constantly provided between the exciting coil 2A and the degaussing member 3A (depicted in FIG. 2). The pressing roller 4 (depicted in FIG. 2) presses and deforms the fixing roller 3 to form the fixing nip between the pressing roller 4 and the fixing roller 3. The magnetic shunt alloy layer 3C prevents the heat-generating layer 3E from being excessively heated. When the pressing roller 4 and the fixing roller 3 form the fixing nip, the fixing roller 3 tends to have a concave shape and thereby the sheet S can easily separate from the fixing roller 3. When the pressing roller 4 presses the fixing roller 3, the metal sleeve 3H, which includes the magnetic shunt alloy layer 3C, the antioxidant layer 3D1, the heat-generating layer 3E, the antioxidant layer 3D2, the elastic layer 3F, and the releasing layer 3G, is deformed, and the degaussing member 3A is not deformed. The degaussing member 3A has a cylindrical roller shape and forms concentric circles with the metal sleeve 3H.

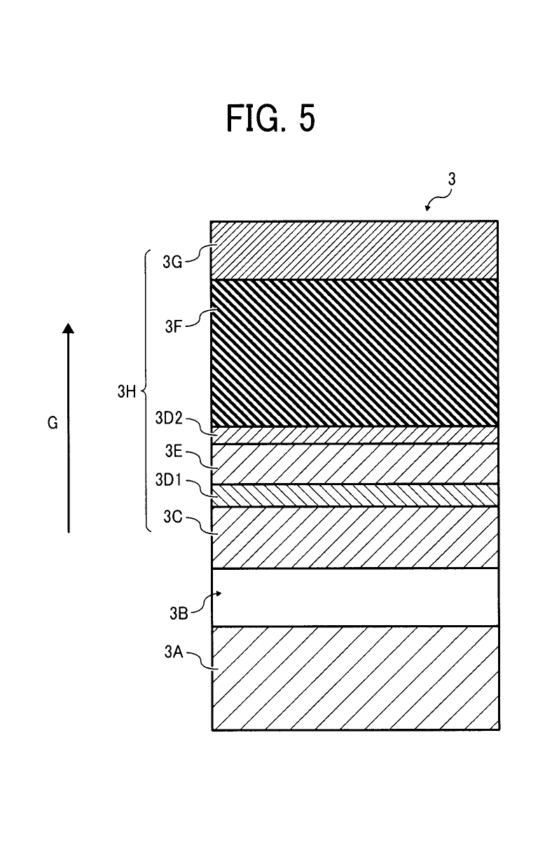

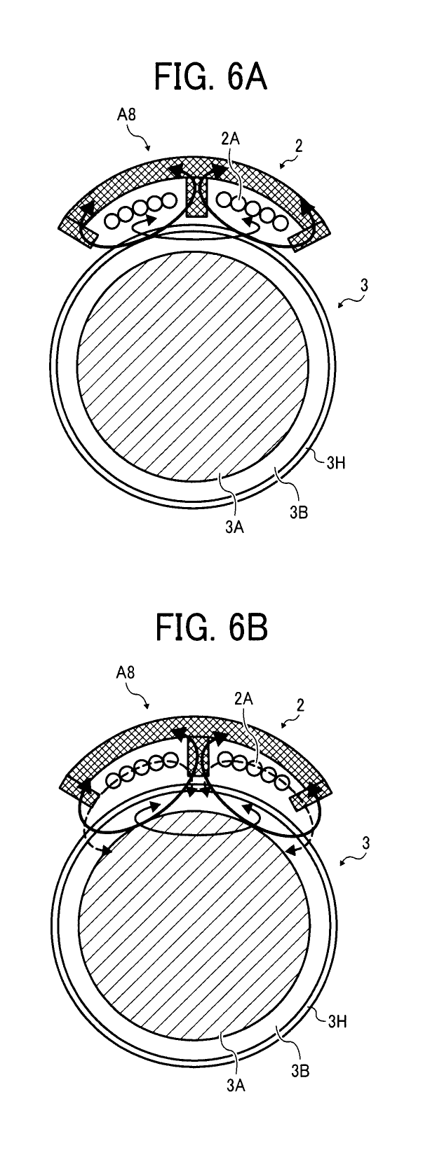

Referring to FIGS. 6A and 6B, the following describes a heat generation suppressing function performed by the degaussing member 3A.

FIG. 6A is a sectional front view of the fixing roller 3 when a temperature T of the magnetic shunt alloy layer 3C (depicted in FIG. 5) is lower than a Curie point Tc and thereby the degaussing member 3A does not cause the magnetic shunt alloy layer 3C to suppress heat generation. In FIG. 6A, thick solid arrows illustrate induction magnetic fluxes generated by the exciting coil 2A and thin solid arrows illustrate eddy currents flowing in the magnetic shunt alloy layer 3C.

When the temperature T of the magnetic shunt alloy layer 3C (e.g., the magnetic shunt alloy included in the magnetic shunt alloy layer 3C) is lower than the Curie point Tc, the magnetic shunt alloy layer 3C included in the metal sleeve 3H has magnetism. Accordingly, the induction magnetic fluxes generated by the exciting coil 2A do not permeate the magnetic shunt alloy layer 3C and the insulating layer 3B.

Namely, when the temperature T of the magnetic shunt alloy layer 3C is lower than the Curie point Tc, the magnetic shunt alloy layer 3C has magnetism. Accordingly, the induction magnetic fluxes generated by the exciting coil 2A do not permeate the magnetic shunt alloy layer 3C provided between the exciting coil 2A and the degaussing member 3A, and thereby do not reach the degaussing member 3A. Thus, a repulsive magnetic field does not generate in the degaussing member 3A, and the magnetic shunt alloy layer 3C does not suppress heat generation. Accordingly, the heat-generating layer 3E (depicted in FIG. 5) generates heat using the induction magnetic fluxes generated by the exciting coil 2A. The heat is transmitted to the magnetic shunt alloy layer 3C. Thus, the temperature T of the magnetic shunt alloy layer 3C can sharply increase to a temperature near the Curie point Tc.

FIG. 6B is a sectional front view of the fixing roller 3 when the temperature T of the magnetic shunt alloy layer 3C (depicted in FIG. 5) is higher than the Curie point Tc and thereby the degaussing member 3A causes the magnetic shunt alloy layer 3C to suppress heat generation. In FIG. 6B, broken arrows illustrate induction magnetic fluxes generated by the degaussing member 3A including aluminum or an alloy of aluminum.

When the temperature T of the magnetic shunt alloy layer 3C is higher than the Curie point Tc, the magnetic shunt alloy layer 3C loses magnetism. Accordingly, the induction magnetic fluxes generated by the exciting coil 2A permeate the magnetic shunt alloy layer 3C provided between the exciting coil 2A and the degaussing member 3A, and thereby reach the degaussing member 3A via the insulating layer 3B. Namely, the induction magnetic fluxes generated by the exciting coil 2A pass through the degaussing member 3A. When the induction magnetic fluxes, which change over time, penetrate the degaussing member 3A serving as a conductor, an induction electric current (e.g., an eddy current) flows in the degaussing member 3A. The eddy current induces repulsive magnetic fluxes for canceling out the induction magnetic fluxes.

When the temperature T of the magnetic shunt alloy layer 3C, that is, the temperature of the magnetic shunt alloy included in the magnetic shunt alloy layer 3C, is higher than the Curie point Tc, the magnetic shunt alloy layer 3C loses magnetism and becomes a non-magnetic body. Thus, even when the insulating layer 3B is provided, induction magnetic fluxes generated by the exciting coil 2A reach the degaussing member 3A. When the degaussing member 3A generates repulsive magnetic fluxes, the repulsive magnetic fluxes cancel out the induction magnetic fluxes generated by the exciting coil 2A, suppressing heat generation. Accordingly, heat generation efficiency of the heat-generating layer 3E (depicted in FIG. 5) for generating heat using the induction magnetic fluxes generated by the exciting coil 2A decreases and thereby the temperature T of the magnetic shunt alloy layer 3C decreases.

As illustrated in FIG. 6A, the magnetic shunt alloy layer 3C, which serves as a magnetic body and provides the above-described function of the heat-generating layer 3E, is heated instantly until the temperature T of the magnetic shunt alloy layer 3C reaches the Curie point Tc. As illustrated in FIG. 6B, when the temperature T of the magnetic shunt alloy layer 3C reaches the Curie point Tc, the magnetic shunt alloy layer 3C loses magnetism and thereby is not heated further, maintaining a constant temperature. Thus, the exciting coil 2A, the degaussing member 3A, the magnetic shunt alloy 3C, and the heat-generating layer 3E interact with each other to provide a self-temperature control function.

Therefore, when the magnetic shunt alloy layer 3C includes a magnetic body including a material having the Curie point Tc in a range of from about 100 degrees centigrade to about 300 degrees centigrade, that is, a temperature used in roller type fixing devices like the fixing device A8 (depicted in FIG. 2), the heat-generating layer 3E and the degaussing member 3A may not be overheated and thereby may maintain a proper fixing temperature. Accordingly, a surface of the fixing roller 3 can provide a proper release property and a proper heat resistance property without complex control.

Alternatively, when the metal sleeve 3H includes a single layer, that is, the magnetic shunt alloy layer 3C, the metal sleeve 3H may include an alloy of iron or nickel and may have a thickness not greater than about 150 μm, so that the metal sleeve 3H deforms to form the fixing nip between the pressing roller 4 (depicted in FIG. 2) and the fixing roller 3 when the pressing roller 4 presses the fixing roller 3. For example, the magnetic shunt alloy layer 3C may include a deformable base layer and a magnetic layer plated on the base layer. Thus, the magnetic shunt alloy layer 3C can be properly deformed with reduced rupture of the magnetic shunt alloy layer 3C.

The insulating layer 3B, above which the magnetic shunt alloy layer 3C is formed, may preferably include a material having a thermal conductivity lower than a thermal conductivity of the magnetic shunt alloy layer 3C. Accordingly, the heat-generating layer 3E (depicted in FIG. 5) may provide an increased thermal efficiency. The insulating layer 3B may include a material having a thermal conductivity (e.g., about 0.1 W/mK) lower than a thermal conductivity of the magnetic shunt alloy layer 3C, such as a foamed silicon rubber. For example, when the magnetic shunt alloy layer 3C has a thermal conductivity of about 11 W/mK, the insulating layer 3B may be an air layer as illustrated in FIG. 5 or other layer. The insulating layer 3B may or may not include an elastic body. When the insulating layer 3B includes the elastic body, pressure (e.g., nip pressure) applied by the pressing roller 4 (depicted in FIG. 2) can be increased to provide an improved fixing property.

The insulating layer 3B may preferably have a thickness of about 10 mm or smaller or any other appropriate thickness calculated based on a strength of a magnetic flux and the like, so as to cause a magnetic flux permeating the magnetic shunt alloy layer 3C to reach a conductive body.

According to this exemplary embodiment, the fixing roller 3, serving as the heat-generating rotary member, has a roller shape. Alternatively, the heat-generating rotary member may have a sleeve shape or a belt shape. When the magnetic shunt alloy layer 3C is provided separately from the heat-generating layer 3E, the magnetic shunt alloy layer 3C may be fixed or may not be fixed to the heat-generating layer 3E. When the magnetic shunt alloy layer 3C is not fixed to the heat-generating layer 3E, a belt or a sleeve may include the heat-generating layer 3E and a roller supporting the belt may include the magnetic shunt alloy layer 3C.

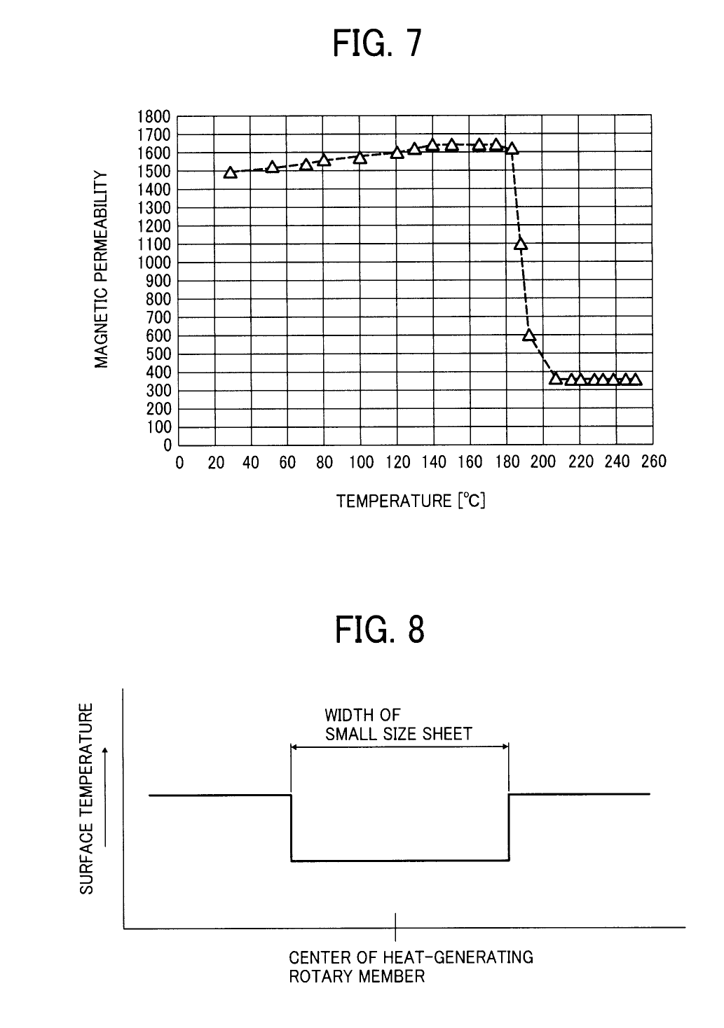

FIG. 7 illustrates a magnetic permeability (e.g., a heat generation efficiency or an inductance permeability) of the magnetic shunt alloy layer 3C (depicted in FIG. 5) varying depending on a temperature. In FIG. 7, Δ indicates a magnetic permeability at each temperature. The fixing device A8 (depicted in FIG. 2) according to this exemplary embodiment has the self-temperature control function and thereby can provide easy temperature control when a fixing temperature is set near the Curie point Tc of 180 degrees centigrade. However, as illustrated in FIG. 7, when the temperature T of the magnetic shunt alloy layer 3C is lower than a predetermined fixing temperature set near the Curie point Tc, the magnetic permeability of the magnetic shunt alloy layer 3C is substantially high. By contrast, when the temperature T of the magnetic shunt alloy layer 3C exceeds the predetermined fixing temperature, the magnetic permeability sharply decreases because energy is consumed as repulsive magnetic fluxes. Consequently, a fixing process for fixing a toner image TN on a sheet S needs to be performed under a decreased heat generation efficiency.

Further, even when a user wants to adjust the fixing temperature according to an environmental temperature, a sheet size, and a fixing property (e.g., gloss), the self-temperature control function of the fixing device A8 does not allow the fixing process performed under a temperature other than the predetermined fixing temperature set near the Curie point Tc of about 180 degrees centigrade, for example.

FIG. 8 illustrates a surface temperature of the fixing roller 3 (depicted in FIG. 2) serving as the heat-generating rotary member varying depending on a position on the fixing roller 3. When the fixing device A8 (depicted in FIG. 2) continuously fixes toner images TN on a plurality of small size sheets S, the surface temperature of a center of the fixing roller 3 in an axial direction of the fixing roller 3 decreases because the small size sheets S contact the center of the fixing roller 3. When the temperature T of the magnetic shunt alloy layer 3C increases to be near the fixing temperature set near the Curie point Tc, more heat is supplied to the degaussing member 3A than to the metal sleeve 3H (depicted in FIG. 2) although the metal sleeve 3H needs to be heated more than the degaussing member 3A. Accordingly, the surface temperature of the center of the fixing roller 3 decreased by the plurality of sheets S may not be increased and recovered to the predetermined fixing temperature. Further, when the fixing temperature is set near the Curie point Tc, the fixing roller 3 may not be sufficiently heated. Especially, under a low environmental temperature, a long time period is needed to warm up the fixing device A8. Namely, the fixing device A8 may not be heated quickly.

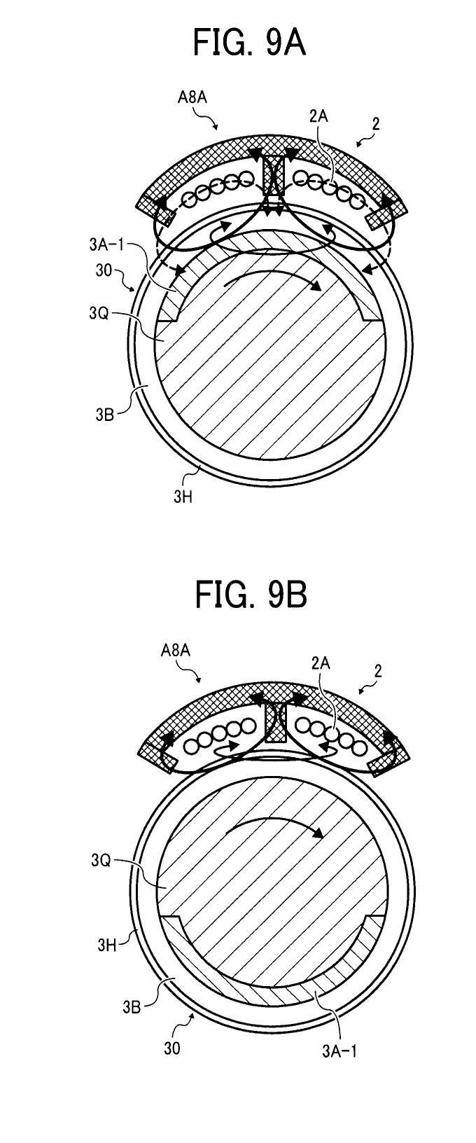

Referring to FIGS. 9A and 9B, the following describes a fixing device A8A according to another exemplary embodiment. The fixing device A8A includes the magnetic flux generator 2 and a fixing roller 30. The fixing roller 30 includes a degaussing member 3A-1 and a magnetic core 3Q instead of the degaussing member 3A of the fixing device A8 depicted in FIG. 2. The other elements of the fixing device A8A are common to the fixing device A8. In FIGS. 9A and 9B, thick solid arrows illustrate induction magnetic fluxes generated by the exciting coil 2A and thin solid arrows illustrate eddy currents flowing in the magnetic shunt alloy layer 3C. Broken arrows illustrate induction magnetic fluxes generated by the degaussing member 3A-1 including aluminum or an alloy of aluminum.

The fixing roller 30 serves as a heat-generating rotary member. The magnetic shunt alloy layer 3C (depicted in FIG. 5) of the fixing device A8A includes a material having a Curie point Tc higher than the fixing temperature set for the fixing device A8 in which a distance between the exciting coil 2A and the degaussing member 3A (depicted in FIG. 2) does not change. Thus, the fixing device A8A can perform a fixing process for fixing a toner image TN on a sheet S with an increased heat generating efficiency. Further, the fixing device A8A can change an amount of repulsive magnetic fluxes to provide a broader range of predetermined temperature for a self-temperature control function.

The degaussing member 3A-1 rotates together with the magnetic core 3Q inside the metal sleeve 3H so that the degaussing member 3A-1 is displaced with respect to the exciting coil 2A. Accordingly, an amount of induction magnetic fluxes generated by the exciting coil 2A and reaching the degaussing member 3A-1 is changed to adjust an amount of repulsive magnetic fluxes generated by the degaussing member 3A-1. Namely, the degaussing member 3A-1 and the magnetic core 3Q are displaced with respect to the exciting coil 2A to adjust the amount of repulsive magnetic fluxes generated by the degaussing member 3A-1.

The magnetic core 3Q includes ferrite having a high magnetic property and a high resistance. The magnetic shunt alloy layer 3C includes an alloy of iron and nickel. The magnetic shunt alloy layer 3C can provide various Curie points Tc by adjusting an amount of nickel. The degaussing member 3A-1 includes a conductive body (e.g., aluminum, an alloy of aluminum, and copper) to have a volume resistivity lower than a volume resistivity of the magnetic shunt alloy layer 3C so as to provide an increased degaussing effect. When the temperature T of the magnetic shunt alloy layer 3C is higher than the Curie point Tc, an eddy current induced by induction magnetic fluxes generated by the exciting coil 2A easily flows in the degaussing member 3A-1 to generate strong repulsive magnetic fluxes. Alternatively, the magnetic core 3Q and the degaussing member 3A-1 may include other materials and may have other shapes.

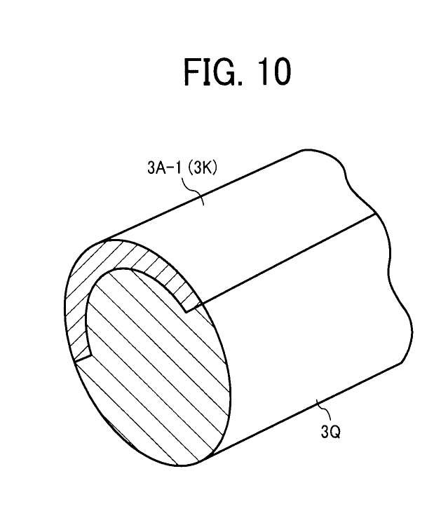

FIG. 10 is a perspective view of the magnetic core 3Q and the degaussing member 3A-1. The degaussing member 3A-1 includes a degaussing material 3K.

The magnetic core 3Q has a substantially cylindrical roller shape. The degaussing material 3K is formed in a plate having a semi-tubular shape in cross section. The degaussing material 3K is attached to a part of an outer circumferential surface of the magnetic core 3Q. Specifically, as illustrated in FIG. 9A, the degaussing member 3A-1 is integrated with the magnetic core 3Q with an attaching member in such a manner that the degaussing member 3A-1 and the magnetic core 3Q rotate inside the metal sleeve 3H, that is, inside the magnetic shunt alloy layer 3C (depicted in FIG. 5), for example. The degaussing member 3A-1 and the magnetic core 3Q, serving as a high-resistance magnetic member, are adjacent to each other along a rotating direction of the magnetic core 3Q having a roller shape. The degaussing material 3K is formed in a planar shape having a semi-circumferential length shorter than a semi-circumference of a circle, and is attached to and integrated with the rotatable magnetic core 3Q. Namely, the semi-circumference of the degaussing material 3K opposes a semi-circumference of the magnetic core 3Q via a center of rotation of the magnetic core 3Q. The magnetic core 3Q rotates inside a circular space formed inside the metal sleeve 3H including the magnetic shunt alloy layer 3C. The magnetic core 3Q can stop rotating at a position at which the degaussing member 3A-1 is close to the magnetic flux generator 2 or at a position at which the degaussing member 3A-1 is away from the magnetic flux generator 2.

Referring to FIG. 11, the following describes a structure for rotating the magnetic core 3Q. FIG. 11 is a sectional side view of the fixing device A8A. The fixing device A8A further includes a left side plate 8L, a right side plate 8R, a left flange 7L, a right flange 7R, a left shaft 6L, a right shaft 6R, a bearing 5, a shaft 9L, and a shaft 9R.

The magnetic flux generator 2 is fixed to the left side plate 8L and the right side plate 8R. The left side plate 8L and the right side plate 8R support the fixing roller 30. The metal sleeve 3H forming an outer circumferential surface of the fixing roller 30 is fixed to the left flange 7L and the right flange 7R.

The right flange 7R supports the right shaft 6R of the magnetic core 3Q provided inside the metal sleeve 3H via the bearing 5. The shaft 9R of the right flange 7R penetrates the right side plate 8R and is supported by the right side plate 8R. The shaft 9R of the right flange 7R is connected to a rotation driver. The left flange 7L supports the left shaft 6L of the magnetic core 3Q via the bearing 5. The left shaft 6L of the magnetic core 3Q penetrates the left flange 7L and protrudes toward an outside of the left flange 7L. The left shaft 6L of the magnetic core 3Q is connected to a driver. The left side plate 8L supports the shaft 9L of the left flange 7L.

The metal sleeve 3H including the magnetic shunt alloy layer 3C (depicted in FIG. 5) has a tubular shape and is ratatable. The exciting coil 2A (depicted in FIG. 9A) of the magnetic flux generator 2 is provided outside the rotating magnetic shunt alloy layer 3C. The degaussing member 3A-1 is provided inside the rotating metal sleeve 3H and rotates with the magnetic core 3Q with respect to the exciting coil 2A.

When the fixing device A8A fixes a toner image TN on a sheet S, the metal sleeve 3H rotates together with the fixing roller 30 in synchronism with the pressing roller 4 (depicted in FIG. 2). By contrast, the magnetic core 3Q and the degaussing member 3A-1 do not rotate together with the fixing roller 30 to be displaced with respect to the magnetic flux generator 2 including the exciting coil 2A.

As described above, the magnetic core 3Q is integrated with the degaussing member 3A-1. The magnetic core 3Q and the degaussing member 3A-1 are supported inside the fixing roller 30 in such a manner that the magnetic core 3Q and the degaussing member 3A-1 rotate independently of the fixing roller 30 to be displaced with respect to the magnetic flux generator 2 including the exciting coil 2A. Namely, a combination of the degaussing member 3A-1 and the magnetic core 3Q is displaced with respect to the exciting coil 2A to serve as a magnetic flux adjuster for adjusting an amount of repulsive magnetic fluxes generated by the degaussing member 3A-1. However, a structure of the magnetic flux adjuster is not limited to the above-described structure and the magnetic flux adjuster may have any structure for moving the magnetic core 3Q inside the metal sleeve 3H.

Referring to FIGS. 9A and 9B, the following describes operations of the magnetic flux adjuster. FIG. 9A is a sectional front view of the fixing device A8A when a degaussing function of the degaussing member 3A-1 is activated. FIG. 9B is a sectional front view of the fixing device A8A when the degaussing function of the degaussing member 3A-1 is not activated.

FIG. 9A illustrates the fixing roller 30 when the temperature T of the magnetic shunt alloy layer 3C (depicted in FIG. 5) is higher than the Curie point Tc and thereby the degaussing function is activated to suppress heat generation. As illustrated in FIG. 9A, the magnetic core 3Q rotates and stops at a position at which the degaussing member 3A-1 opposes the exciting coil 2A, that is, at a close position at which the degaussing member 3A-1 is close to the exciting coil 2A. When the temperature T of the magnetic shunt alloy layer 3C is higher than the Curie point Tc, the magnetic shunt alloy layer 3C loses magnetism to become a non-magnetic body, providing an increased degaussing function.

The following describes a self-temperature control function provided by the fixing device A8A. When the degaussing member 3A-1 is close to the exciting coil 2A, the degaussing function is fully activated. Specifically, when the temperature T of the magnetic shunt alloy layer 3C is higher than the Curie point Tc, induction magnetic fluxes (illustrated in the thick solid lines) generated by the exciting coil 2A penetrate the magnetic shunt alloy layer 3C and reach the degaussing member 3A-1 forming an aluminum layer, and an eddy current generates in the aluminum layer. The eddy current (illustrated in the thin solid line) generates in a direction for canceling out the induction magnetic fluxes generated by the exciting coil 2A. Accordingly, repulsive magnetic fluxes (illustrated in the broken lines) generate in a direction for canceling out the induction magnetic fluxes generated by the exciting coil 2A.

The induction magnetic fluxes (illustrated in the thick solid lines) generated by the exciting coil 2A penetrate the magnetic shunt alloy layer 3C when the temperature T of the magnetic shunt alloy layer 3C is higher than the Curie point Tc. When the temperature T of the magnetic shunt alloy layer 3C is near the Curie point Tc, especially, is higher than the Curie point Tc, an increased amount of repulsive magnetic fluxes generates. Accordingly, an amount of induction magnetic fluxes generated by the exciting coil 2A decreases. The decreased amount of induction magnetic fluxes causes the heat-generating layer 3E (depicted in FIG. 5) to generate a decreased amount of eddy currents. Consequently, the heat-generating layer 3E generates a decreased amount of heat. The decreased amount of heat decreases the temperature T of the magnetic shunt alloy layer 3C to the Curie point Tc. Accordingly, a decreased amount of induction magnetic fluxes penetrates the magnetic shunt alloy layer 3C, but an amount of induction magnetic fluxes passing through the heat-generating layer 3E increases as an amount of repulsive magnetic fluxes decreases. Consequently, the heat-generating layer 3E generates an increased amount of heat.

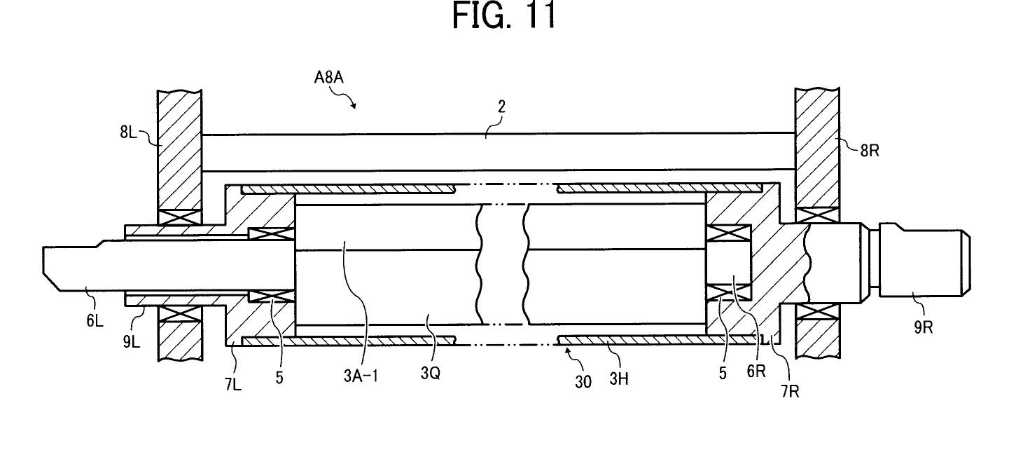

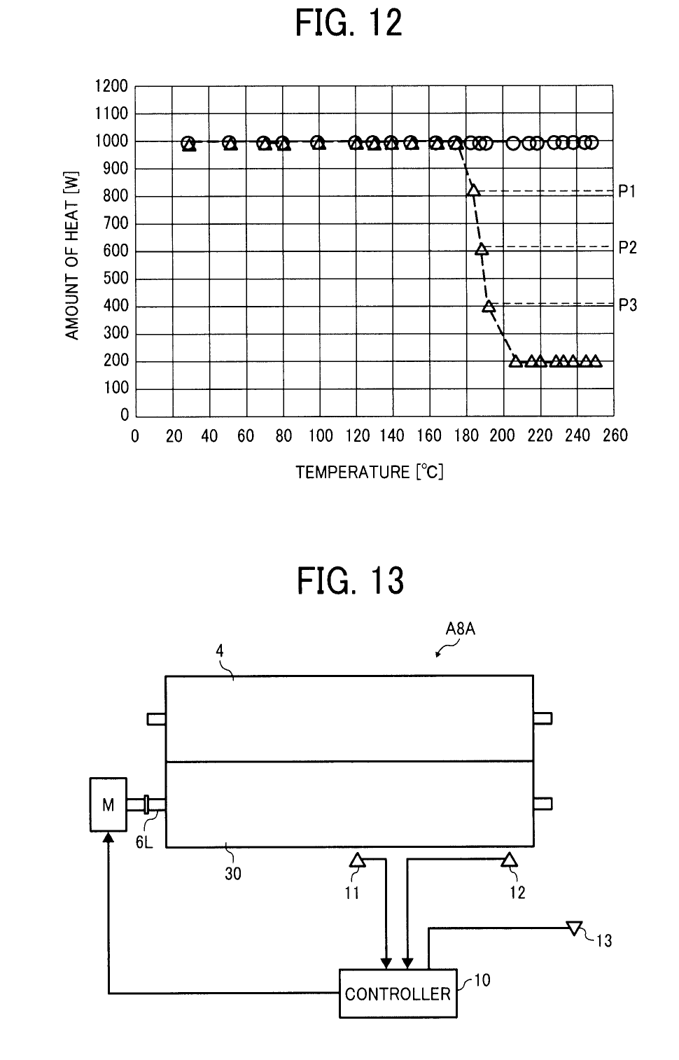

An amount of heat generated by the heat-generating layer 3E is automatically controlled so that the temperature T of the magnetic shunt alloy layer 3C is near the Curie point Tc as illustrated in a characteristic line formed by triangles Δ over 200 degrees centigrade in FIG. 12. FIG. 12 illustrates an amount of generated heat varying depending on a temperature. In FIG. 12, triangles Δ indicate characteristics shown when the degaussing function is activated as illustrated in FIG. 9A. Circles ∘ indicate characteristics shown when the degaussing function is not activated as illustrated in FIG. 9B.

If the degaussing function is fully activated and the temperature T of the magnetic shunt alloy layer 3C is lower than the Curie point Tc, induction magnetic fluxes generated by the exciting coil 2A do not pass through the magnetic shunt alloy layer 3C, and thereby repulsive magnetic fluxes do not generate. Accordingly, the induction magnetic fluxes generated by the exciting coil 2A generate eddy currents in the heat-generating layer 3E without constraints. Thus, the heat-generating layer 3E can generate a maximum amount of heat, as illustrated in FIG. 12 by a characteristic line formed by triangles Δ at and under 180 degrees centigrade when the heat-generating layer 3E generates the maximum amount of heat of 1,000 W.

When the magnetic core 3Q rotates and stops to locate the degaussing member 3A-1 at an intermediate position between the position of the degaussing member 3A-1 illustrated in FIG. 9A and the position of the degaussing member 3A-1 illustrated in FIG. 9B, the heat-generating layer 3E generates amounts of heat indicated by characteristic lines P1, P2, and P3 extending in a horizontal direction from triangles Δ over 180 degrees centigrade and under 200 degrees centigrade in FIG. 12. When the degaussing member 3A-1 is at the intermediate position, the degaussing function is not fully activated and the heat-generating layer 3E generates various amounts of heat in a stepless manner.

Controlling the magnetic core 3Q to locate the degaussing member 3A-1 at the intermediate position to cause the heat-generating layer 3E to generate the amounts of heat shown by the characteristic lines P1, P2, and P3 can suppress temperature increase of the fixing roller 30. When the fixing device A8A including the fixing roller 30 stores a substantial amount of heat and thereby the fixing roller 30 is heated quickly, the degaussing function can be enhanced to suppress temperature increase of the fixing roller 30. When the fixing roller 30 is excessively heated, faulty fixing may occur. Moreover, when the degaussing member 3A-1 moves directly from the position illustrated in FIG. 9B to the position illustrated in FIG. 9A without stopping at the intermediate position while the temperature T of the magnetic shunt alloy layer 3C is higher than the Curie point Tc, impedance of the exciting coil 2A may change substantially, resulting in improper control of power supply. However, when the degaussing member 3A-1 stops at the intermediate position, impedance of the exciting coil 2A can change slowly, reducing load to control power supply.

FIG. 9B illustrates the fixing roller 30 when the degaussing function is not activated even when the temperature T of the magnetic shunt alloy layer 3C (depicted in FIG. 5) is higher than the Curie point Tc, and thereby heat generation is not suppressed. As illustrated in FIG. 9B, the magnetic core 3Q rotates and stops at the position at which the magnetic core 3Q opposes the exciting coil 2A. Accordingly, the degaussing member 3A-1 stops at a position opposite to the position at which the magnetic core 3Q opposes the exciting coil 2A via the center of rotation of the magnetic core 3Q. Namely, the degaussing member 3A-1 is at a position farthest away from the exciting coil 2A. When the temperature T of the magnetic shunt alloy layer 3C is higher than the Curie point Tc, the magnetic shunt alloy layer 3C loses magnetism to become a non-magnetic body. Induction magnetic fluxes generated by the exciting coil 2A permeate the magnetic shunt alloy layer 3C, but the degaussing member 3A-1 does not generate repulsive magnetic fluxes because the degaussing member 3A-1 is away from the exciting coil 2A. Thus, the degaussing function is not activated and an amount of heat generated by the heat-generating layer 3E does not decrease. The induction magnetic fluxes generated by the exciting coil 2A illustrated in the thick solid lines in FIG. 9B are attracted to the magnetic core 3Q. Accordingly, the heat-generating layer 3E generates eddy currents without constraints to generate heat, that is, the maximum amount of heat of 1,000 W shown by a characteristic line formed by circles ∘ over 180 degrees centigrade in FIG. 12.

If the degaussing function is not fully activated and the temperature T of the magnetic shunt alloy layer 3C is lower than the Curie point Tc, the heat-generating layer 3E generates eddy currents without constraints and thereby generates heat, as illustrated in FIG. 12 by a characteristic line formed by circles ∘ at and under 180 degrees centigrade when the heat-generating layer 3E generates the maximum amount of heat of 1,000 W. Namely, the heat-generating layer 3E can generate the maximum amount of heat.

Rotating and moving the degaussing member 3A-1 together with the magnetic core 3Q can provide desired heat generation control. Specifically, control data including information about a rotation angle of the magnetic core 3Q and a surface temperature of the fixing roller 30 is prepared based on data shown in FIG. 12. The position of the degaussing member 3A-1 is changed with respect to the exciting coil 2A based on information about an operation mode (e.g., a warm-up mode, an image forming mode, or an energy-saving mode) of the fixing device A8A or the image forming apparatus 1000 (depicted in FIG. 1) and information about temperature provided by a temperature sensor provided in the fixing device A8A. Thus, heat generation by the magnetic shunt alloy layer 3C is controlled.

Referring to FIG. 13, the following describes an example of heat generation control. The fixing device A8A further includes a controller 10, temperature sensors 11, 12, and 13, and a motor M.

The controller 10 includes a CPU (central processing unit) storing the above-described control data on a storage medium. The temperature sensors 11 and 12 are provided near a center and an end of the fixing roller 30 in an axial direction (e.g., a longitudinal direction) of the fixing roller 30, respectively. The temperature sensors 11 and 12 serve as temperature detectors for detecting a surface temperature of the surface of the fixing roller 30 and send a detection result to the controller 10. The temperature sensor 13 detects a room temperature of a location at which the image forming apparatus 1000 (depicted in FIG. 1) including the fixing device A8A is located, and sends a detection result to the controller 10.

The motor M (e.g., a stepping motor) is connected to the left shaft 6L of the fixing roller 30 and is driven by the controller 10 to rotate the left shaft 6L. When the fixing device A8A is in the warm-up mode, the controller 10 calculates a proper position of the degaussing member 3A-1 (depicted in FIG. 9A) based on the detection results provided by the temperature sensors 11, 12, and 13, and drives the motor M to move the degaussing member 3A-1 to the proper position so that the degaussing member 3A-1 can generate proper repulsive magnetic fluxes.

As illustrated in FIG. 8, after a plurality of small size sheets continuously moves on and contacts the fixing roller 30 serving as the heat-generating rotary member, the surface temperature of the center of the fixing roller 30 in the axial direction of the fixing roller 30 becomes lower than the surface temperature of the two ends of the fixing roller 30 in the axial direction of the fixing roller 30. To prevent the decreased surface temperature of the center of the fixing roller 30 from deteriorating fixing quality, the controller 10 drives the motor M based on the detection results provided by the temperature sensors 11, 12, and 13 so that the degaussing member 3A-1 can generate proper repulsive magnetic fluxes. For example, when the degaussing function is not activated as illustrated in FIG. 9B, the center of the fixing roller 30 can quickly recover a proper temperature. The controller 10 monitors the surface temperature of the fixing roller 30 to adjust the surface temperature whenever the surface temperature decreases. Further, when the fixing device A8A is in the warm-up mode, the controller 10 controls the magnetic flux adjuster so that the degaussing function is not activated as illustrated in FIG. 9B. Thus, a warm-up time period can be shortened.

Gloss of a toner image on a sheet may vary depending on a fixing temperature. A high fixing temperature is needed to form a glossy toner image in a glossy print mode. A relatively low fixing temperature is needed to form a non-glossy toner image in a normal print mode.

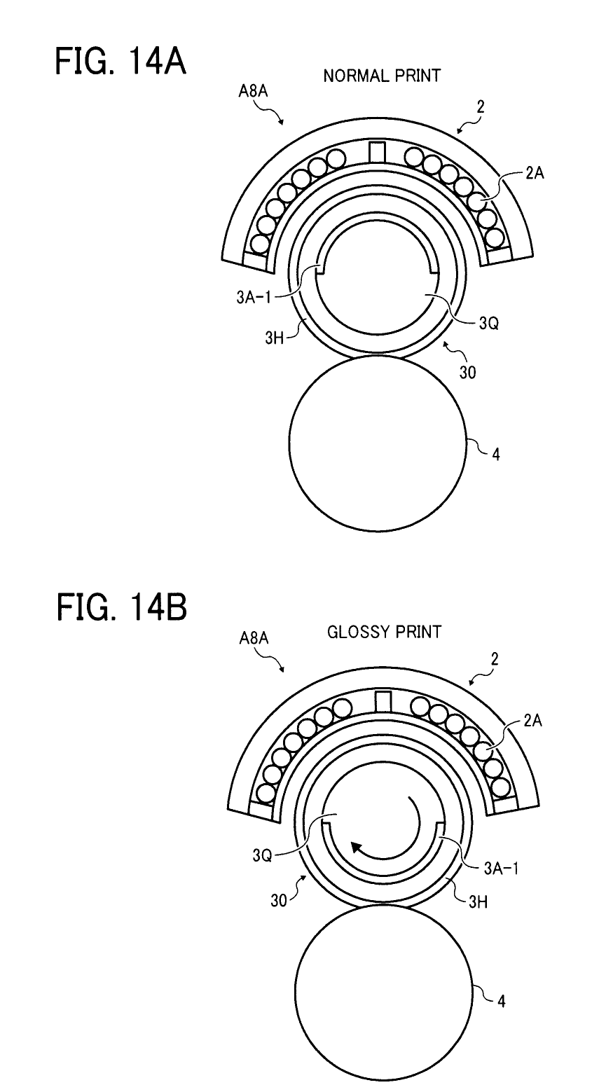

FIG. 14A illustrates the fixing device A8A in the normal print mode in which the degaussing function is activated as illustrated in FIG. 9A. FIG. 14B illustrates the fixing device A8A in the glossy print mode in which the degaussing function is not activated as illustrated in FIG. 9B. The degaussing function is not activated as illustrated in FIG. 9B to form a color toner image because the color toner image needs more gloss than a monochrome toner image.

As described above, the controller 10 (depicted in FIG. 13) controls the magnetic flux adjuster based on information about the operation mode of the fixing device A8A, such as the warm-up mode and a mode for continuously fixing toner images on small size sheets, and information about quality of a fixed toner image, such as a glossy toner image and a non-glossy toner image. Namely, the controller 10 adjusts an amount of repulsive magnetic fluxes generated by the degaussing member 3A-1 to provide desired fixing quality and temperature increase effect.

As illustrated in FIG. 13, the temperature sensors 11 and 12 send detection results (e.g., the surface temperatures of the fixing roller 30) to the controller 10 as needed. The controller 10 calculates a difference between the surface temperatures of the fixing roller 30 sent by the temperature sensors 11 and 12 and a desired temperature, and drives the motor M to adjust the position of the magnetic core 3Q (depicted in FIG. 9A). Thus, the controller 10 performs a feedback control to provide further improved fixing quality and temperature increase effect.

The following describes the heat-generating rotary member. The fixing roller 3 (depicted in FIG. 2) and the fixing roller 30 (depicted in FIG. 9A) may be a fixing roller or a fixing sleeve deformed by pressure applied by a pressing roller. Each of the fixing roller 3 and the fixing roller 30 includes the metal sleeve 3H (depicted in FIGS. 2 and 9A) having a thickness not greater than about 200 μm and is deformed by pressure applied by the pressing roller 4 (depicted in FIG. 2). Alternatively, a rigid roller including the metal sleeve 3H having a thickness greater than about 200 μm and not deformed by pressure applied by the pressing roller 4 can have the degaussing function like the fixing roller 30. Therefore, the heat-generating rotary member according to the above-described exemplary embodiments may include both the fixing sleeve and the fixing roller.

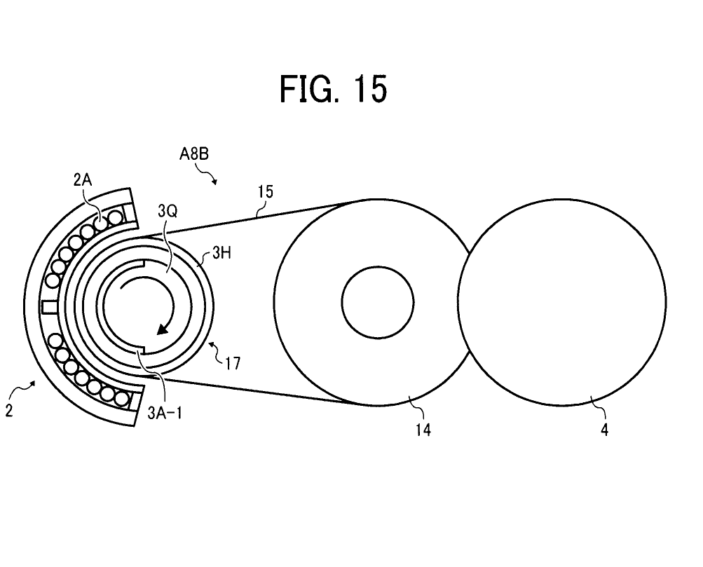

FIG. 15 is a sectional front view of a fixing device A8B according to yet another exemplary embodiment. The fixing device A8B includes the magnetic flux generator 2, the pressing roller 4, a roller 14, a fixing belt 15, and a heating roller 17. The magnetic flux generator 2 includes the exciting coil 2A. The heating roller 17 includes the metal sleeve 3H, the magnetic core 3Q, and the degaussing member 3A-1. The other elements of the fixing device A8B are common to the fixing device A8A depicted in FIG. 9A.

The fixing belt 15 is looped over the roller 14 and the heating roller 17. The roller 14 is disposed opposite and pressed against the pressing roller 4 via the fixing belt 15. The roller 14 and the heating roller 17 rotatably support the fixing belt 15. The heating roller 17 serves as a heat-generating rotary member and heats the fixing belt 15. The metal sleeve 3H has a thickness greater than about 200 μm to be rigid.

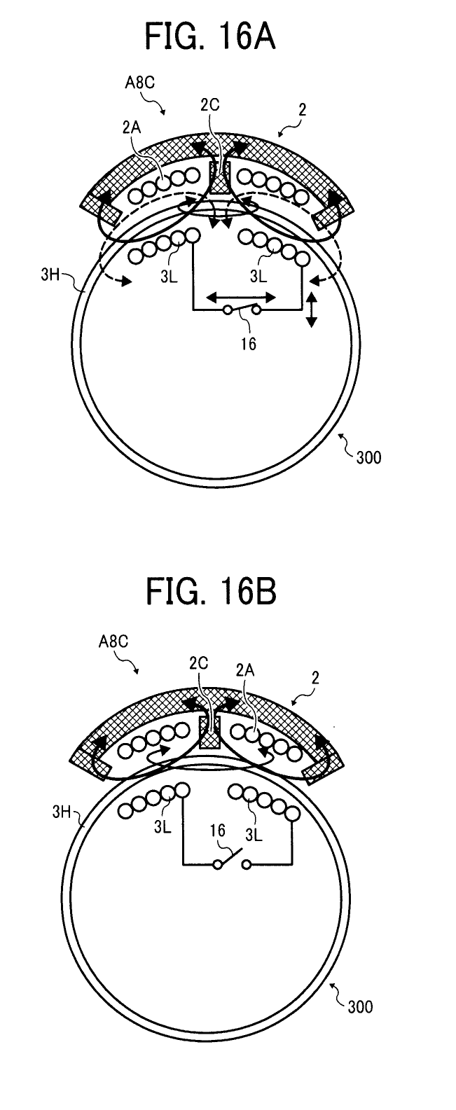

Referring to FIGS. 16A and 16B, the following describes a fixing device A8C according to yet another exemplary embodiment. The fixing device A8C includes the magnetic flux generator 2 and a fixing roller 300. The magnetic flux generator 2 includes the exciting coil 2A and the center core 2C. The fixing roller 300 includes the metal sleeve 3H, degaussing coils 3L, and a switch element 16.

The fixing roller 300 serves as a heat-generating rotary member. The structure of the magnetic flux generator 2 and the metal sleeve 3H is equivalent to the structure of the magnetic flux generator 2 and the metal sleeve 3H depicted in FIG. 9A. The fixing roller 300 includes a pair of degaussing coils 3L instead of the degaussing member 3A-1 and the magnetic core 3Q depicted in FIG. 9A.

The pair of degaussing coils 3L is provided inside the metal sleeve 3H including the magnetic shunt alloy layer 3C (depicted in FIG. 5). Unlike the left shaft 6L and the left side plate 8L (depicted in FIG. 11), the left shaft 6L is fixed to the left side plate 8L in the fixing device A8C. Thus, even when the metal sleeve 3H rotates, the pair of degaussing coils 3L is not displaced with respect to the exciting coil 2A.

The switch element 16 shorts or opens (e.g., connects or breaks) connection between the degaussing coils 3L to suppress induction magnetic fluxes generated by the exciting coil 2A. Therefore, a mechanism for moving the degaussing coils 3L is not needed, saving space.

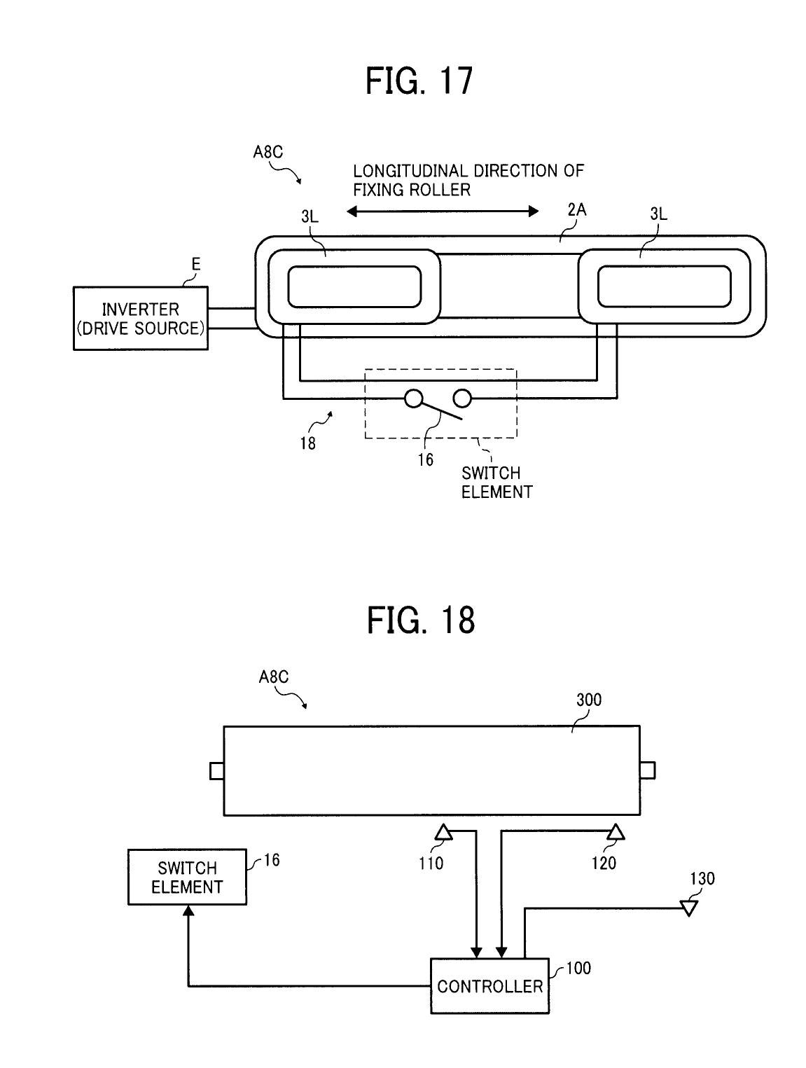

Referring to FIG. 17, the following describes a relation among the exciting coil 2A, the degaussing coils 3L, the switch element 16, and the inverter E. The fixing device A8C further includes a circuit 18. The circuit 18 includes the degaussing coils 3L and the switch element 16. The switch element 16 turns on and off the degaussing function. A switch, a variable resistive element, or other device may be used as the switch element 16. A driver is not provided for the degaussing coils 3L serving as sub coils.

As illustrated in FIG. 16A, the exciting coil 2A is divided into left and right portions by the center core 2C. A plurality of degaussing coils 3L, preferably three degaussing coils 3L, may be provided for each of the left and right portions of the exciting coil 2A. However, according to this exemplary embodiment, one or more degaussing coils 3L may be provided for each of the left and right portions of the exciting coil 2A, and a number of degaussing coils 3L is not limited. The degaussing function is controlled according to a switch rate of the switch element 16 per unit time.

FIG. 16A is a sectional front view of the fixing roller 300 when the degaussing coils 3L are turned on to activate the degaussing function, and thereby heat generation is suppressed. The switch element 16 is turned on to short (e.g., connect) the connection between the degaussing coils 3L. Accordingly, induction magnetic fluxes generated by the exciting coil 2A are reduced to activate the degaussing function.

When the degaussing coils 3L are turned on (e.g., connected), the degaussing function is fully activated. When the temperature T of the magnetic shunt alloy layer 3C (depicted in FIG. 5) is higher than the Curie point Tc, induction magnetic fluxes (illustrated in thick solid lines in FIG. 16A) generated by the exciting coil 2A pass through the magnetic shunt alloy layer 3C and reach the degaussing coils 3L. An electric current is induced in the degaussing coils 3L in a direction for canceling out the induction magnetic fluxes generated by the exciting coil 2A. Simultaneously, the degaussing coils 3L generate repulsive magnetic fluxes (illustrated in broken lines in FIG. 16A) in a direction for canceling out the induction magnetic fluxes generated by the exciting coil 2A.

Induction magnetic fluxes generated by the exciting coil 2A (illustrated in the thick solid lines) pass through the magnetic shunt alloy layer 3C when the temperature T of the magnetic shunt alloy layer 3C is higher than the Curie point Tc. When the temperature T of the magnetic shunt alloy layer 3C is near the Curie point Tc, especially, higher than the Curie point Tc, an amount of repulsive magnetic fluxes generated by the degaussing coils 3L increases and an amount of induction magnetic fluxes generated by the exciting coil 2A decreases. Accordingly, an amount of eddy currents generated in the heat-generating layer 3E (depicted in FIG. 5) using the induction magnetic fluxes decreases. Consequently, the heat-generating layer 3E generates a decreased amount of heat.

When the amount of heat generated by the heat-generating layer 3E decreases, the temperature T of the magnetic shunt alloy layer 3C decreases to the Curie point Tc. Accordingly, a decreased amount of induction magnetic fluxes passes through the magnetic shunt alloy layer 3C. However, a decreased amount of repulsive magnetic fluxes increases an amount of induction magnetic fluxes passing through the heat-generating layer 3E. Thus, the heat-generating layer 3E generates an increased amount of heat. Namely, the amount of heat generated by the heat-generating layer 3E is automatically controlled so that the temperature T of the magnetic shunt alloy layer 3C is near the Curie point Tc, as illustrated in the characteristic line formed by triangles Δ over 200 degrees centigrade in FIG. 12.

If the degaussing function is activated and the temperature T of the magnetic shunt alloy layer 3C is lower than the Curie point Tc, induction magnetic fluxes generated by the exciting coil 2A do not pass through the magnetic shunt alloy layer 3C, and thereby the degaussing coils 3L do not generate repulsive magnetic fluxes. Accordingly, the induction magnetic fluxes generated by the exciting coil 2A generate eddy currents in the heat-generating layer 3E without constraints. Thus, the heat-generating layer 3E can generate a maximum amount of heat, as illustrated in FIG. 12 by the characteristic line formed by triangles Δ at and under 180 degrees centigrade when the heat-generating layer 3E generates the maximum amount of heat of 1,000 W.

When the switch element 16 has a variable resistive function or includes a variable resistive device, the amount of repulsive magnetic fluxes generated by the degaussing coils 3L is adjusted to a medium level between an amount generated when the switch element 16 is turned on as illustrated in FIG. 16A and an amount generated when the switch element 16 is turned off as illustrated in FIG. 16B. For example, the heat-generating layer 3E generates amounts of heat indicated by the characteristic lines P1, P2, and P3 extending in the horizontal direction from the triangles Δ over 180 degrees centigrade and under 200 degrees centigrade in FIG. 12. Namely, the degaussing function is not fully activated and the heat-generating layer 3E generates various amounts of heat in a stepless manner.

Controlling the degaussing function to generate the amounts of heat shown by the characteristic lines P1, P2, and P3 can suppress temperature increase of the fixing roller 300. When the fixing device A8C including the fixing roller 300 stores a substantial amount of heat and thereby the fixing roller 300 is heated quickly, the degaussing function can be enhanced to suppress temperature increase of the fixing roller 300. When the fixing roller 300 is excessively heated, faulty fixing may occur. Moreover, when the switch element 16 is turned off and on without controlling the heat-generating layer 3E to generate the amounts of heat indicated by the characteristic lines P1, P2, and P3 in FIG. 12 while the temperature T of the magnetic shunt alloy layer 3C is higher than the Curie point Tc, impedance of the exciting coil 2A may change substantially, resulting in improper control of power supply. However, controlling the heat-generating layer 3E to generate the amounts of heat indicated by the characteristic lines P1, P2, and P3 in FIG. 12 can change impedance of the exciting coil 2A slowly, reducing load to control power supply.

FIG. 16B is a sectional front view of the fixing roller 300 when the degaussing coils 3L are turned off to deactivate the degaussing function, and thereby heat generation is not suppressed. The switch element 16 is turned off to break the connection between the degaussing coils 3L. Accordingly, degaussing magnetic fluxes are not generated to deactivate the degaussing function.

The switch element 16 is turned off and induction magnetic fluxes generated by the exciting coil 2A permeate the magnetic shunt alloy layer 3C. However, when the temperature T of the magnetic shunt alloy layer 3C is higher than the Curie point Tc, the degaussing coils 3L do not generate repulsive magnetic fluxes. Accordingly, the heat-generating layer 3E generates eddy currents without constraints to generate heat, that is, the maximum amount of heat of 1,000 W shown by the characteristic line formed by the circles ∘ over 180 degrees centigrade in FIG. 12.

If the degaussing coils 3L are turned off to deactivate the degaussing function and the temperature T of the magnetic shunt alloy layer 3C is lower than the Curie point Tc, the heat-generating layer 3E generates eddy currents without constraints and thereby generates heat, as illustrated in FIG. 12 by the characteristic line formed by the circles ∘ at and under 180 degrees centigrade when the heat-generating layer 3E generates the maximum amount of heat of 1,000 W. Namely, the heat-generating layer 3E can generate the maximum amount of heat.

Using the switch element 16 as a variable resistive device for changing a resistance can provide a desired heat generation control. Specifically, control data including information about the resistance of the variable resistive device and a surface temperature of the fixing roller 300 is prepared based on data shown in FIG. 12. The resistance of the variable resistive device is changed based on information about an operation mode (e.g., a warm-up mode, an image forming mode, or an energy-saving mode) of the fixing device A8C or the image forming apparatus 1000 (depicted in FIG. 1) and information about temperature provided by a temperature sensor included in the fixing device A8C. Thus, heat generation by the magnetic shunt alloy layer 3C is controlled.

Referring to FIG. 18, the following describes an example of heat generation control. The fixing device A8C further includes a controller 100 and temperature sensors 110, 120, and 130.

The controller 100 includes a CPU storing the above-described control data. The temperature sensors 110 and 120 are provided near a center and an end of the fixing roller 300 in an axial direction (e.g., a longitudinal direction) of the fixing roller 300, respectively. The temperature sensors 110 and 120 serve as temperature detectors for detecting the surface temperature of the surface of the fixing roller 300 and send a detection result to the controller 100. The temperature sensor 130 detects a room temperature of a location at which the image forming apparatus 1000 (depicted in FIG. 1) including the fixing device A8C is located, and sends a detection result to the controller 100.

The controller 100 controls turning on and off the switch element 16 or the resistance. When the fixing device A8C is in the warm-up mode, the controller 100 controls the switch element 16 based on the detection results provided by the temperature sensors 110, 120, and 130 so that the degaussing coils 3L (depicted in FIG. 16A) can generate proper repulsive magnetic fluxes.

As illustrated in FIG. 8, after a plurality of small size sheets continuously moves on and contacts the fixing roller 300 serving as the heat-generating rotary member, the surface temperature of the center of the fixing roller 300 in the axial direction of the fixing roller 300 becomes lower than the surface temperature of the two ends of the fixing roller 300 in the axial direction of the fixing roller 300. To prevent the decreased surface temperature of the center of the fixing roller 300 from deteriorating fixing quality, the controller 100 performs control based on the detection results provided by the temperature sensors 110, 120, and 130 so that the degaussing coils 3L can generate proper repulsive magnetic fluxes, as described above.

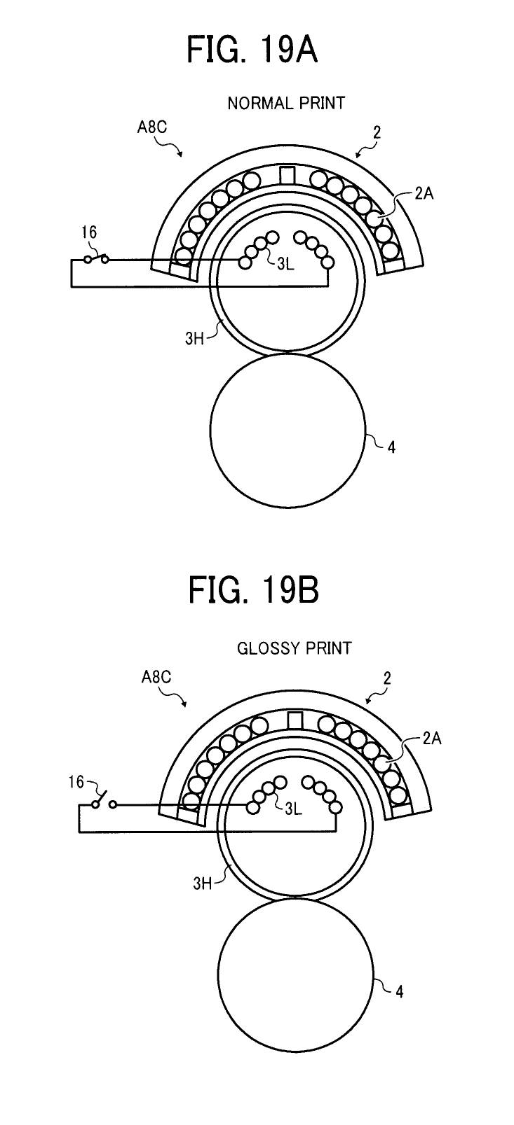

FIG. 19A illustrates the fixing device A8C in the normal print mode in which the degaussing coils 3L are shorted (e.g., connected) and thereby the degaussing function is activated as illustrated in FIG. 16A. FIG. 19B illustrates the fixing device A8C in the glossy print mode in which the degaussing function is not activated as illustrated in FIG. 16B. In the glossy print mode, the connection between the degaussing coils 3L is opened (e.g., broken) and the degaussing function is not activated as illustrated in FIG. 16B to form a color toner image because the color toner image needs more gloss than a monochrome toner image.

As described above, the controller 100 (depicted in FIG. 18) controls the magnetic flux adjuster based on information about the operation mode of the fixing device A8C, such as the warm-up mode and the mode for continuously fixing toner images on small size sheets, and information about quality of a fixed toner image, such as a glossy toner image and a non-glossy toner image. Namely, the controller 100 adjusts an amount of repulsive magnetic fluxes generated by the degaussing coils 3L to provide desired fixing quality and temperature increase effect.

As illustrated in FIG. 18, the temperature sensors 110 and 120 send detection results (e.g., the surface temperatures of the fixing roller 300) to the controller 100 as needed. The controller 100 calculates a difference between the surface temperatures of the fixing roller 300 sent by the temperature sensors 110 and 120 and a desired temperature, and adjusts the resistance of the switch element 16. Thus, the controller 100 performs a feedback control to provide further improved fixing quality and temperature increase effect.

The following describes the heat-generating rotary member. According to this exemplary embodiment, the fixing roller 300 serves as the heat-generating rotary member. Alternatively, the heat-generating rotary member may include a rigid fixing roller including the metal sleeve 3H having a thickness greater than about 200 μm and not deformed by pressure applied by the pressing roller 4 (depicted in FIG. 19A).

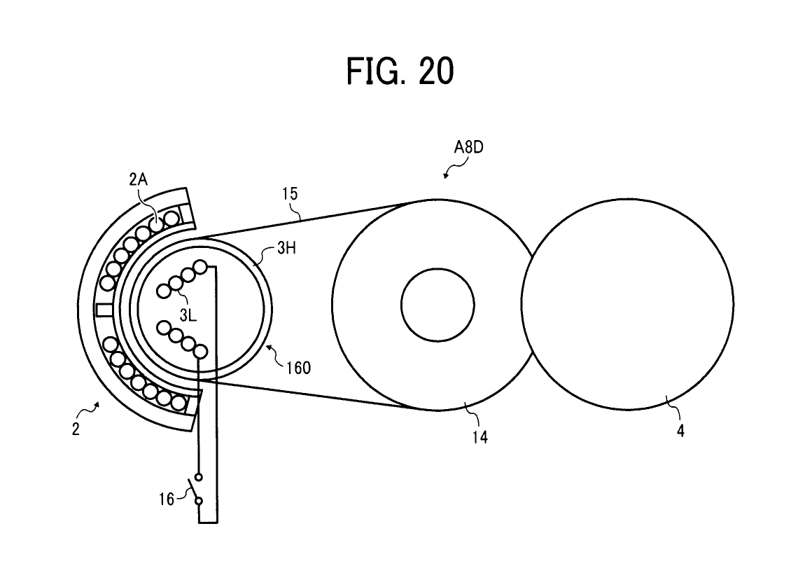

FIG. 20 is a sectional front view of a fixing device A8D according to yet another exemplary embodiment. The fixing device A8D includes the magnetic flux generator 2, the pressing roller 4, the fixing belt 15, the roller 14, and a heating roller 160. The magnetic flux generator 2 includes the exciting coil 2A. The heating roller 160 includes the degaussing coils 3L, the switch element 16, and the metal sleeve 3H.

The fixing belt 15 is looped over the roller 14 and the heating roller 160. The roller 14 is disposed opposite and pressed against the pressing roller 4 via the fixing belt 15. The roller 14 and the heating roller 160 rotatably support the fixing belt 15. The heating roller 160 serves as a heat-generating rotary member and heats the fixing belt 15. The metal sleeve 3H has a thickness greater than about 200 μm to be rigid.

The image forming apparatus 1000 (depicted in FIG. 1) handles various sizes of sheets including small size sheets and large size sheets. When small size sheets are continuously fed and contact the fixing roller 3 (depicted in FIG. 2), the fixing roller 30 (depicted in FIG. 9A), the fixing roller 300 (depicted in FIG. 16A), or the fixing belt 15 (depicted in FIGS. 15 and 20), the small size sheets decrease the surface temperature of the center of the fixing roller 3, 30, or 300 in the axial direction of the fixing roller 3, 30, or 300 or a center of the fixing belt 15 in a width direction of the fixing belt 15, resulting in faulty fixing. In a fixing sleeve including a conventional degaussing member, an upper limit of a fixing temperature is set near a Curie point, resulting in a decreased heat generation efficiency.

By contrast, according to the above-described exemplary embodiments, the magnetic shunt alloy layer 3C (depicted in FIG. 5) has the Curie point Tc higher than a typical fixing temperature. Further, when the degaussing function is activated, fixing can be performed at a fixing temperature lower than the high Curie point Tc indicated by the characteristic lines P1, P2, and P2 in FIG. 12 while providing an appropriate heat generation efficiency.

In order to prevent faulty fixing which occurs when the surface temperature of the center of the fixing roller 3, 30, or 300 in the axial direction of the fixing roller 3, 30, or 300 or the center of the fixing belt 15 in the width direction of the fixing belt 15 decreases, the degaussing function is not activated to increase the surface temperature of the center of the fixing roller 3, 30, or 300 or the fixing belt 15 by quickly heating the entire fixing roller 3, 30, or 300 including both ends of the fixing roller 3, 30, or 300 in the axial direction of the fixing roller 3, 30, or 300 or the entire fixing belt 15 including both ends of the fixing belt 15 in the width direction of the fixing belt 15. When the small size sheets continuously contact the fixing roller 3, 30, or 300 or the fixing belt 15, the degaussing function is deactivated whenever the surface temperature of the fixing roller 3, 30, or 300 or the fixing belt 15 decreases over time.

Even in winter when an environmental temperature is low, the fixing device A8 (depicted in FIG. 2), A8A (depicted in FIG. 9A), A8B (depicted in FIG. 15), A8C (depicted in FIG. 16A), or A8D (depicted in FIG. 20) can be quickly heated by deactivating the degaussing function. Thus, the fixing device A8, A8A, A8B, A8C, or A8D can be warmed up to a proper fixing temperature in a short time period.

According to the above-described exemplary embodiments, an amount of repulsive magnetic fluxes generated by the degaussing member (e.g., the degaussing member 3A-1 depicted in FIG. 9A or the degaussing coil 3L depicted in FIG. 16A) can be changed to adjust suppression of heat generation. Namely, heat generated by the heat-generating layer (e.g., the heat-generating layer 3E depicted in FIG. 5) is controlled. Accordingly, the magnetic shunt alloy layer 3C (depicted in FIG. 5) can be heated to a temperature higher than the Curie point quickly by induction heating, improving quality of a fixed toner image and warming up the fixing device (e.g., the fixing device A8, A8A, A8B, A8C, or A8D) quickly.

The present invention has been described above with reference to specific exemplary embodiments. Note that the present invention is not limited to the details of the embodiments described above, but various modifications and enhancements are possible without departing from the spirit and scope of the invention. It is therefore to be understood that the present invention may be practiced otherwise than as specifically described herein. For example, elements and/or features of different illustrative exemplary embodiments may be combined with each other and/or substituted for each other within the scope of the present invention.

What is claimed is:

1. An image forming apparatus, comprising:
a fixing device configured to fix a toner image on a sheet by applying heat, comprising:
an exciting coil configured to generate a magnetic flux; and
a heat-generating rotary member configured to perform self-temperature control using a repulsive magnetic flux,
the heat-generating rotary member comprising:
a degaussing member configured to generate the repulsive magnetic flux using the magnetic flux generated by the exciting coil;
a heat-generating layer configured to generate heat using the magnetic flux generated by the exciting coil;
a magnetic shunt alloy layer disposed between the exciting coil and the degaussing member and configured to receive heat generated by the heat-generating layer; and
a magnetic flux adjuster configured to adjust an amount of the repulsive magnetic flux generated by the degaussing member.

2. The image forming apparatus according to claim 1,
wherein the magnetic flux adjuster displaces the degaussing member with respect to the exciting coil to adjust an amount of the magnetic flux generated by the exciting coil and reaching the degaussing member.

3. The image forming apparatus according to claim 2,
wherein the degaussing member is rotatable so as to displace with respect to the exciting coil.

4. The image forming apparatus according to claim 3,
wherein the fixing device further comprises a high-resistance magnetic member having a rotatable roller shape and provided adjacent to the degaussing member along a rotating direction of the high-resistance magnetic member.

5. The image forming apparatus according to claim 4,
wherein the degaussing member has a planar shape comprised of one of aluminum and copper, and the high-resistance magnetic member includes ferrite, and
wherein the degaussing member is attached to a part of the high-resistance magnetic member.

6. The image forming apparatus according to claim 5,
wherein the degaussing member includes a degaussing material disposed opposite the high-resistance magnetic member via a center of rotation of the high-resistance magnetic member.

7. The image forming apparatus according to claim 4,
wherein the magnetic shunt alloy layer has a rotatable tubular shape and the exciting coil is provided outside the rotating magnetic shunt alloy layer, and
wherein the degaussing member is combined with the high-resistance magnetic member and disposed inside the rotating magnetic shunt alloy layer, in such a manner that the degaussing member and the high-resistance magnetic member rotate with respect to the exciting coil.

8. The image forming apparatus according to claim 1,
wherein the degaussing member includes a material having a volume resistivity lower than a volume resistivity of the magnetic shunt alloy layer.

9. The image forming apparatus according to claim 1,
wherein the degaussing member comprises a degaussing coil configured to generate a degaussing magnetic flux to cancel out the magnetic flux generated by the exciting coil, and
wherein the magnetic flux adjuster comprises a switch element configured to adjust an amount of the degaussing magnetic flux generated by the degaussing coil,
the switch element including one of a switch and a variable resistive device provided in a circuit including the degaussing coil.

10. The image forming apparatus according to claim 9,
wherein the heat-generating layer and the magnetic shunt alloy layer are integrated into a rotatable tube, and
wherein the exciting coil is provided outside the rotatable magnetic shunt alloy layer and the degaussing member is provided inside the rotatable tube.

11. The image forming apparatus according to claim 1,
wherein the fixing device further comprises a pressing roller disposed opposite the heat-generating rotary member and configured to apply pressure to the heat-generating rotary member to form a fixing nip thereat, at which the pressing roller and the heat-generating rotary member fix a toner image on a sheet passing through the fixing nip, and
wherein the heat-generating rotary member comprises one of a fixing sleeve deformable at the fixing nip by the pressure applied by the pressing roller and a fixing roller not deformable at the fixing nip by the pressure applied by the pressing roller.

12. The image forming apparatus according to claim 1,
wherein the fixing device further comprises:
a fixing belt supported by the heat-generating rotary member;
a roller configured to support the fixing belt; and
a pressing roller disposed opposite the roller via the fixing belt and configured to apply pressure to the fixing belt to form a fixing nip thereat, at which the pressing roller and the fixing belt fix a toner image on a sheet passing through the fixing nip,
wherein the heat-generating rotary member heats the fixing belt.

13. The image forming apparatus according to claim 11,
wherein the fixing device further comprises:
a temperature detector configured to detect a temperature of the heat-generating rotary member; and
a controller configured to adjust the amount of the repulsive magnetic flux by controlling the magnetic flux adjuster based on the temperature detected by the temperature detector.

14. The image forming apparatus according to claim 11,
wherein the fixing device further comprises a controller configured to adjust the amount of the repulsive magnetic flux by controlling the magnetic flux adjuster based on an operation mode of the fixing device and information about desired quality of a fixed toner image.

15. The image forming apparatus according to claim 14,
wherein the controller controls the magnetic flux adjuster to deactivate the degaussing member when the fixing device is in a warm-up mode.

16. A fixing device, comprising:
an exciting coil configured to generate a magnetic flux; and
a heat-generating rotary member configured to perform self-temperature control using a repulsive magnetic flux,
the heat-generating rotary member comprising:
a degaussing member configured to generate the repulsive magnetic flux using the magnetic flux generated by the exciting coil;
a heat-generating layer configured to generate heat using the magnetic flux generated by the exciting coil;
a magnetic shunt alloy layer disposed between the exciting coil and the degaussing member and configured to receive heat generated by the heat-generating layer; and
a magnetic flux adjuster configured to adjust an amount of the repulsive magnetic flux generated by the degaussing member.

17. A heat-generating rotary member, comprising:
a metal sleeve comprising:
a heat-generating layer configured to generate heat using a magnetic flux; and
a magnetic shunt alloy layer configured to receive heat generated by the heat-generating layer;
a roller including ferrite as a high-resistance magnetic material; and
a degaussing member rotatably provided inside the metal sleeve, the degaussing member including one of an aluminum plate and a copper plate attached to a part of the roller.
